(19) United States
(12) Patent Application Publication
(10) Pub. No.: US 2026/0149740 A1
(43) Pub. Date: May 28, 2026

(54) DYNAMIC RESOURCE COMPLIANCE DETERMINATION FOR CONTAINERIZED SYSTEMS

(71) Applicant: International Business Machines Corporation, Armonk, NY (US)

(72) Inventors: JIE KE FANG, Beijing (CN); Xiao Ling Chen, Beijing (CN); Heng Wang, Beijing (CN); Shi Su, BEIJING (CN)

(21) Appl. No.: 18/957,934

(22) Filed: Nov. 25, 2024

(51) Int. Cl. H04L 9/40

(52) U.S. Cl. CPC H04L 63/20

(57) ABSTRACT

A system may include a memory and a processor in communication with the memory. The processor may be configured to perform operations. The operations may include monitoring network actions between resources within a network and extracting encryption data from said network actions. The operations may include detecting connection security data from said encryption data and obtaining a resource health report for a resource in said network. The operations may include merging connection security data with said resource health report and generating a security compliance report.

### BACKGROUND

The disclosure relates generally to container-based environments and more specifically to resource deployment in a container-based environment.

A container-based environment, architecture, or platform provides a structure for automating deployment, scaling, and operations of application workloads across one or more clusters of host nodes. A container-based environment may include a host node hosts components of an application workload that is deployed to the host; a host node may be either physical or virtual. A container-based environment may include a control node that manages the workload of the cluster and directs communication across the cluster.

Container-based environments may be used to store various information including sensitive data such as passwords, authorization tokens, and access credentials. Some container-based environments use secrets to securely provide cryptographic certificates and keys to applications. Security certificates, encryption algorithms, and various access controls ensure the security of sensitive data.

### SUMMARY

Embodiments of the present disclosure include a system, method, and computer program product for resource deployment security compliance in a container-based environment. A system in accordance with some embodiments of the present disclosure may include a memory and a processor in communication with the memory. The processor may be configured to perform operations. The operations may include monitoring network actions between resources within a network and extracting encryption data from the network actions. The operations may include detecting connection security data from the encryption data and obtaining a resource health report for a resource in the network. The operations may include merging connection security data with the resource health report and generating a security compliance report.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an architecture for a resource deployment system in accordance with some embodiments of the present disclosure.

FIG. 2A depicts a deployment architecture for a resource deployment compliance system in accordance with some embodiments of the present disclosure.

FIG. 2B illustrates a development architecture for a resource deployment compliance system in accordance with some embodiments of the present disclosure.

FIG. 3 depicts a flowchart of compliance detection using a resource deployment system in accordance with some embodiments of the present disclosure.

FIG. 4 illustrates playbooks for a resource deployment system in accordance with some embodiments of the present disclosure.

FIG. 5 depicts a compliance report graph in accordance with some embodiments of the present disclosure.

FIG. 6 illustrates a compliance analysis module of a resource deployment compliance system in accordance with some embodiments of the present disclosure.

FIG. 7 depicts a connection compliance registry for a resource deployment compliance system in accordance with some embodiments of the present disclosure.

FIG. 8 illustrates a computer-implemented resource deployment compliance method in accordance with some embodiments of the present disclosure.

FIG. 9 depicts a method for a container-based deployment system in accordance with some embodiments of the present disclosure.

FIG. 10 illustrates a computer-implemented method for a container-based deployment system accordance with some embodiments of the present disclosure.

FIG. 11 depicts a block diagram illustrating an embodiment of a computer system configured to operate in a network environment (including a cloud environment), and the components thereof, upon which embodiments including systems and methods described herein may be implemented in accordance with the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to container-based environments and more specifically to resource deployment in a container-based environment.

Container-based environments may be used to store various information including sensitive data such as passwords, access and/or authorization tokens (e.g., OAuth tokens), and access credentials (e.g., SSH keys). A container-based environment, which may also be referred to as a containerized environment or a containerization environment, may be, for example, a node, a cluster, or a supercluster. Some container-based environments use secrets to securely provide cryptographic certificates and keys to applications. Security certificates, encryption algorithms, and various access controls ensure the security of sensitive data.

An example use case for secrets is securely providing cryptographic certificates and keys to applications. In containerized environments, cryptographic assets such as secrets may be mounted into pods as files or environment variables to make them accessible to applications. However, the security and compliance may be complicated and therefore insufficiently managed for cryptographic assets mounted into pods as files or environment variables. As security threats evolve, it becomes imperative to analyze and ensure the compliance and security of these certificates and keys, addressing potential issues like expired certificates, weak encryption algorithms, and misconfigured access controls. The present disclosure enables security and compliance for containerized systems via identification and indication of security and compliance of containerized resources.

In some embodiments, the present disclosure enables identification and/or indication of whether a containerization resource is security compliant. In some embodiments, the present disclosure enables identification and/or indication of whether a connection between containerization resources is security compliant.

An administrator may be unaware of whether or not a containerization deployment is security compliant. Some embodiments of the present disclosure may include the identification of security compliance issues and the indication of any security compliance issues to the administrator. In some embodiments, resources with one or more potential risks may be identified. Moreover, other security concerns may be identified, such as security exploits in certificates and/or keys that the resource has used, weak encryption algorithms used by certificates and/or keys that the resource has used, and certificates and/or keys that the resource configured to use weak encryption algorithms. Identified security concerns may be automatically corrected based on current protocols and/or identified to an administrator.

In some circumstances, a team may be responsible for developing different components for a product; the product may be too large for the team to manually identify a resource within the product that is not compliant with current security protocols in an allotted time. In some circumstances, dependencies between resources may be complex and frequently revised such that the status of security compliance would optimally be detected and updated dynamically. Aspects of the present disclosure may provide solutions for automatically and/or dynamically identifying and indicating security compliance concerns for resources and/or dependencies between resources.

The present disclosure offers solutions for identifying, indicating, and/or correcting security compliance concerns by, in some embodiments, automatically analyzing mounted secrets within pods, extracting cryptographic certificates and/or keys, and evaluating the cryptographic certificates and/or keys against a set of predefined compliance and security rules.

In some embodiments, the present disclosure includes a parameter to represent the extended dependency relationship; this parameter may be referred to as the rdhd parameter. Moreover, another parameter is introduced to represent the list of resources within a containerized environment as well as the resource certificates and/or keys; this parameter may be referred to as the mounted security secrets parameter. The resource certificates and/or keys may be evaluated against a set of predefined compliance and security rules.

In some embodiments, the present disclosure offers a network monitor that monitors the network transactions, captures the transmission control protocol (TCP) connections within the container environment, identifies both ends of the connection (e.g., the resources on either side of a connection), and stores the connections in a registry (e.g., a connection compliance registry). In some embodiments, the registry acts as a storage space to store the connections between two resources. The registry may mark the compliance status as red, yellow, or green; red compliance status may indicate the resource and/or connection as having a common vulnerability and/or exposure (CVE), yellow compliance status may indicate the compliance of a resource and/or connection is not detected, and green compliance status may indicate the compliance of a resource and/or connection is in full compliance with current security protocols.

In some embodiments, the present disclosure offers a security compliance handler that parses the mounted security secrets parameter in a deployment health report graph, extracts cryptographic certificates and/or keys, and evaluates the extracted assets against compliance criteria. Compliance criteria may include, for example, certificate expiration dates, key length, encryption algorithms, and more. With this information, the compliance status for the resource can be identified and marked. The security compliance handler may merge the compliance status of the resources in a containerized environment and the compliance status of connections between resources in the environment to generate a security compliance report graph. The security compliance report graph may include the security compliance status of each resource within a containerization environment and the compliance status of connections between multiple resources within the environment.

The present disclosure enables a user to quickly determine the overall security compliance of a resource deployment and allows the user to address security issues by using resource compliance graph to resolve resource security issues. The present disclosure offers quick status updates when a compliance violation (e.g., a potential security issue) is identified. The present disclosure offers a mechanism for automatically alerting an administrator about compliance violations and security risks.

The present disclosure offers a solution for automatically analyzing mounted secrets within containerization environment pods, extracting cryptographic certificates and/or keys, and evaluating the cryptographic certificates and/or keys against a set of predefined compliance and security rules. The present disclosure offers a mechanism for monitoring the network connections in the containerized environment and detecting security vulnerabilities of connections within the network; in some embodiments, a monitor may detect security vulnerabilities of connections within the network based on a deployment health report graph of the network. The present disclosure enables establishing a security compliance report graph to indicate network security protocol compliance and/or noncompliance to a user.

A parameter may be used in development to represent an extended dependency relationship; this parameter may be referred to as the rdhd parameter. A parameter may be used to represent a list of resources within a containerized environment and the keys of the resources; this parameter may be referred to as the mounted security secrets parameter. The keys of the resources contain the certificates of the resources; the keys may be evaluated against a set of predefined compliance and security rules.

A network monitor may be used to monitor network transactions on a network; in some embodiments, the network monitor may be a network cryptographic connection monitor. The network monitor may capture TCP connections in the container environment, identify both ends of the connection (e.g., the resources on either side of a connection), and store the connections in a registry (e.g., a connection compliance registry). In some embodiments, the registry acts as a storage space to store the connections between two resources. The registry may mark the compliance status as red, yellow, or green; red compliance status may indicate the resource and/or connection as having a common vulnerability and/or exposure (CVE), yellow compliance status may indicate the compliance of a resource and/or connection is not detected, and green compliance status may indicate the compliance of a resource and/or connection is in full compliance with current security protocols.

In some embodiments, the present disclosure offers a security compliance handler that parses the mounted security secrets parameter in a deployment health report graph, extracts cryptographic certificates and/or keys, and evaluates the extracted assets against compliance criteria. Compliance criteria may include, for example, certificate expiration dates, key length, encryption algorithms, and more. The compliance status for the resource and/or the connections to the resource can thus be identified and marked. The security compliance handler may combine the compliance status of the resources in a containerized environment and the compliance status of connections between resources in the environment to generate a security compliance report graph. The security compliance report graph may include the security compliance status of each resource within a containerization environment and the compliance status of connections between multiple resources within the environment. In some embodiments, the security compliance report graph may be based on a deployment health report dependency graph.

In some embodiments, a system in accordance with the present disclosure may include one or more operators with updated modules. The system may include a dependency store; the modules may report data (e.g., dependency information) to the dependency store, and the dependency store may use the data to generate a deployment health dependency graph. The system may include a deployment controller; the deployment controller may submit report graph files to a security compliance hander. The system may include a network monitor to monitor the network and submit the monitoring data to a registry; the registry data may be used by the security compliance handler to generate a security compliance report.

In some embodiments of the present disclosure, an updated module may be used in each operator within a containerized environment; the updated modules may report dependencies to a dependency store (e.g., a resource deployment health dependency store). The dependency store may report the dependencies to a controller (e.g., a resource health deployment controller). The controller may generate or update a dependency report graph with the dependency information. The network monitor (e.g., a network cryptographic monitor) may monitor transactions over the connections within the network to identify connections within the network and store the connections data within a registry (e.g., a connection compliance registry).

In some embodiments, the connections data stored in the registry may be used by a security compliance handler to generate a security compliance report graph. The security compliance handler may parse a mounted security secrets parameter, extract cryptographic certificates and/or keys, and evaluate the extracted assets against compliance criteria. The security compliance handler can thus identify compliance statuses of a resource and/or its connections and thereby generate a security compliance report graph.

Some embodiments of the present disclosure may include a resource deployment health dependency module inside an operator; the resource deployment health dependency module may automatically generate a resource deployment health dependency store. The resource deployment health dependency store may analyze the dependency items in the store to thereby build a resource deployment health dependency graph. The resource deployment health dependency graph defines resource relationships such as the dependencies and preconditions of the resource. In some embodiments, the resource deployment health dependency graph may be stored in a configmap.

In accordance with the present disclosure, a user may generate a virtual deployment instance; the user may be, for example, an administrator, a developer, and/or a tester. The virtual deployment instance may contain the name and variables in the custom resource (CR); for example, the virtual deployment instance may contain the knowledge graph configmap name and related variables in the virtual deployment CR.

Some embodiments of the present disclosure may also include a network monitor; the network monitor may monitor the actions between resources on the network. The network monitor may detect whether or not connections between resources are secure and store the connection security data in a registry. The registry may be a connection compliance registry; a connection compliance registry may specifically store connection security compliance data.

Some embodiments of the present disclosure may further include a resource health deployment controller; the resource health deployment controller may generate a resource deployment health report graph report according to the CR; the resource deployment health report graph report may be a configmap. The resource deployment health report graph describes the resource relationships within the network (e.g., the cluster).

Some embodiments of the present disclosure may also include a server to read the resource deployment health report graph report (e.g., a resource deployment health report graph configmap) and generate a resource deployment health report graph; the server may be a dashboard user interface (UI) server. The resource deployment health report graph may show the entirety of the dependency relationship data of a resource. In some situations, a resource that should exist may be missing; in such a circumstance, the resource may be marked in the resource deployment health report graph as missing (e.g., the resource may be marked with a status of missing).

Some embodiments of the present disclosure may further include a security compliance handler. The security compliance handler may update reports and/or graph files with the compliance status of each resource and/or the connections of each resource. The security compliance handler may merge the connection information from the registry (e.g., the connection compliance registry) with established information (e.g., initial report graph files). The security compliance handler may generate a security compliance report graph using the reports, graph files, updated data, resource compliance status data, and/or connection compliance status data.

In some embodiments of the present disclosure, a method includes deploying a resource within a container-based environment and identifying a mounted security secret. A security compliance handler determines whether or not the mounted security secret is compliant with current security protocols. If the mounted security secret is not compliant with current security protocols, the compliance check type is set to non-compliant; if the mounted security secret is compliant with current security protocols, the compliance check type is set to compliant. The method continues by defining resource dependencies to determine dependencies; the method includes identifying mounted security secrets for each dependency and performing dependency checks. A network monitor (e.g., a network cryptographic connection monitor) monitors the network to determine the compliance status of each connection within the network; a non-compliant connection may be marked in red as CVE, a missing connection may be marked in yellow as not detected, and a compliant connection may be marked in green as compliant. The connection status data may be saved and used to update a security compliance record of the container-based system. In some embodiments, the method may loop to check for updates regarding compliance statuses and/or dependencies.

In some embodiments of the present disclosure, one or more playbooks may be used to implement resource deployment compliance. A containerized system may have a resource deployment health dependency (RDHD) module to extract dependency rules from tasks; in some embodiments, the RDHD module may be customized. A field may be included in a mounted secret that contains information related to certificate configuration. A mounted security secret parameter may include a name field with the name of the secret that contains the certificate or key as well as a key field with the name filed in the secret which contains the binary value of a certificate or key.

Some embodiments of the present disclosure may include a report graph. The report graph may be referred to as a compliance report graph, a deployment report graph, or a deployment compliance report graph. The report graph is a map of a network with indicators marking which resources and connections within the network are in compliance with current security protocols, which resources and connections within the network are not in compliance with current security protocols, and which resources and connections that should be in the network are missing or otherwise not detected within the network. A network monitor (e.g., a network cryptographic connection monitor) may detect the compliance, non-compliance, and/or missing status of resources and/or connections within the network.

The report graph may include indicators identifying resource compliance; a compliant resource indicator indicates that a workload is using a certificate that is security compliant. The report graph may include indicators identifying resource non-compliance; a non-compliant resource indicator indicates that a workload is using a certificate that is not security compliant. The report graph may include indicators identifying a missing resource; a missing resource indicator indicates that a resource is expected to be in the network but is not detected.

The report graph may include indicators identifying connection compliance (e.g., a green line between a first resource and a second resource dependent on the first resource); a compliant connection indicator indicates that a connection does not have any security vulnerabilities. The report graph may include indicators identifying connection non-compliance or CVE (e.g., a red line between a first resource and a second resource dependent on the first resource); a non-compliant connection indicator indicates that a connection has security vulnerabilities. The report graph may include indicators identifying a missing connection (e.g., a yellow line between a first resource and a resource dependent on the first resource); a missing resource indicator indicates that a connection that is expected to be in the network is not detected.

Some embodiments of the present disclosure may include a registry (e.g., connection compliance registry). The registry may include data about the resources and/or dependencies within a container-based environment to provide a robust schema for tracking resource and dependency data, including security compliance data. In some embodiments, resource data may be stored in a resources table and resource relationship information such as dependency data may be stored in a dependency table; the resource table may capture important details and status of each resource and the dependency table may map out the relationships between the resources within the network. A resource table and a dependency table may enable better management and monitoring of the resources and dependencies in a network. The schema of using a resource table and a dependency table may be particularly useful for applications needing to enforce and validate resource dependencies before performing certain operations (e.g., generating resources and/or updating connections) to ensure a consistent and reliable state within a cluster.

A resource object may store information about various resources within a network; the resources that the resource object stores information about may be referred to as resources managed by the resource object. Each entry in the resource object represents a unique resource with specific attributes that defines the resource; this information may include, for example, the identity (ID), name, type, and/or current status of the resource. In some embodiments, the resource object may store resource information in a resources table.

A dependency object may store information about the dependencies between resources. Each entry in the dependency object represents a relationship between two resources (e.g., one resource depending on another resource). The information in the dependency object may enable understanding and managing dependencies in a containerized environment. In some embodiments, the dependency object may store resource relationship information in a dependency table.

The present disclosure offers a mechanism for dynamically determining resource deployment compliance in a container-based system. In some embodiments, the present disclosure is easily applicable to operator deployment products. In some embodiments, the present disclosure offers a mechanism to automatically generate and save dependency data structures, including to a configmap. Some embodiments may directly show complex dependency logic for components within a system, for example, via a graph. In some embodiments, testers and/or developers may contribute to resource relationship building. Some embodiments of the present disclosure may help developers to debug issues within a network; some embodiments may help users (e.g., developers, customers, and/or clients) understand product logic. Using the present disclosure, a site reliability engineer (SRE) may be able to easily identify a problematic component and thus be able to quickly restore the system to fully operational status.

The present disclosure provides a mechanism to diagnose the deployment health of a container-based system by identifying dependency paths. Moreover, the disclosure offers a mechanism to improve collaboration between parties interested in a deployment (e.g., developer, tester, deployer, and end user); in some embodiments, one or more parties may adjust one or more dependency relationships in real time. In some embodiments, the disclosure may define and show both deployment dependencies and business dependencies; some embodiments may focus on the resource deployment stage. Some aspects of the present disclosure do not require physical connections between processes. In some embodiments, the disclosure may define and show the dependencies of the deployment process. In some embodiments, a dependency graph may be generated before a network topology may be generated and connected.

Some aspects of the present disclosure may include parameters and attributes such as, for example, a rdhd parameter, a mounted security secrets parameter, a dependencies attribute, an external dependency service attribute, a preconditions attribute, and a dependency type attribute. These parameters and attributes may be included in playbooks using the present disclosure. The present disclosure further discusses features including a resource deployment health dependency module (which may be deployed within an engine), a dependency store, and/or a dependency graph. Some aspects of the present disclosure may enable a user to manually, visually, and/or dynamically adjust one or more dependency relationships within a system; in some embodiments, the user may adjust relationships using an interactive panel.

In accordance with some embodiments of the present disclosure, a computer-implemented method may include analyzing mounted secrets within a containerized deployable unit in a network and extracting cryptographic certificates from said containerized deployable unit. The method may further include evaluating said cryptographic certificates against a set of security rules and monitoring network connections in said network. The method may further include detecting security data in said network connections and generating a security compliance report graph based on said security data.

In accordance with some embodiments of the present disclosure, a method may include generating a resource deployment health dependency store and building a resource deployment health dependency graph. The method may further include generating a virtual deployment instance; the virtual deployment instance may contain a virtual deployment custom resource. The method may further include producing a resource deployment health report graph configmap based on the virtual deployment custom resource. The method may further include monitoring network actions between resources, extracting an encryption algorithm from the network actions, and detecting connection security data based on the encryption algorithm. The method may further include storing the connection security data in a connection compliance registry. The method may further include updating the initial report graph files with the compliance status of each resource, merging the connection security data with the initial report graph files, and generating a security compliance report graph.

A system in accordance with some embodiments of the present disclosure may include a memory and a processor in communication with the memory. The processor may be configured to perform operations. The operations may include monitoring network actions between resources within a network and extracting encryption data from the network actions. The operations may include detecting connection security data from the encryption data and obtaining a resource health report for a resource in the network. The operations may include merging connection security data with the resource health report and generating a security compliance report.

In some embodiments of the present disclosure, monitoring the network actions may include capturing an exchange between the resources. In some embodiments, an exchange between resources may be a network action; in some embodiments, a network action may be a client message or a server response. In some embodiments, the exchange may include a handshake, a message, and a response to the message. In some embodiments, the exchange may be between a server and a client. In some embodiments, the exchange may include a client message (i.e., a message from a client) and a server response (i.e., a response from a server).

In some embodiments of the present disclosure, the encryption data may include at least one of an encryption algorithm, a cryptographic certificate, an encryption key, and an encryption key length. In some embodiments, the operations may include extracting a key length from the network actions; the connection security data may be based on the encryption data and the key length.

In some embodiments of the present disclosure, the operations may include generating a virtual deployment instance. In some embodiments, the virtual deployment instance may include a custom resource.

In some embodiments of the present disclosure, the operations may include generating a resource deployment health report graph. In some embodiments, the resource deployment health report graph may include resources within the network, resource relationships within the network, and statuses within the network. In some embodiments, the resource deployment health report graph may be a configmap.

In some embodiments of the present disclosure, the operations may include updating a resource deployment health report graph.

In some embodiments of the present disclosure, the operations may include building the resource health report. In some embodiments, building the resource health report may include analyzing dependencies within the network, defining the resources within the network, defining relationships within the network, and defining conditions within the network.

In some embodiments of the present disclosure, the operations may include generating a resource deployment health dependency store. In some embodiments, the resource health report is based on the resource deployment health dependency store.

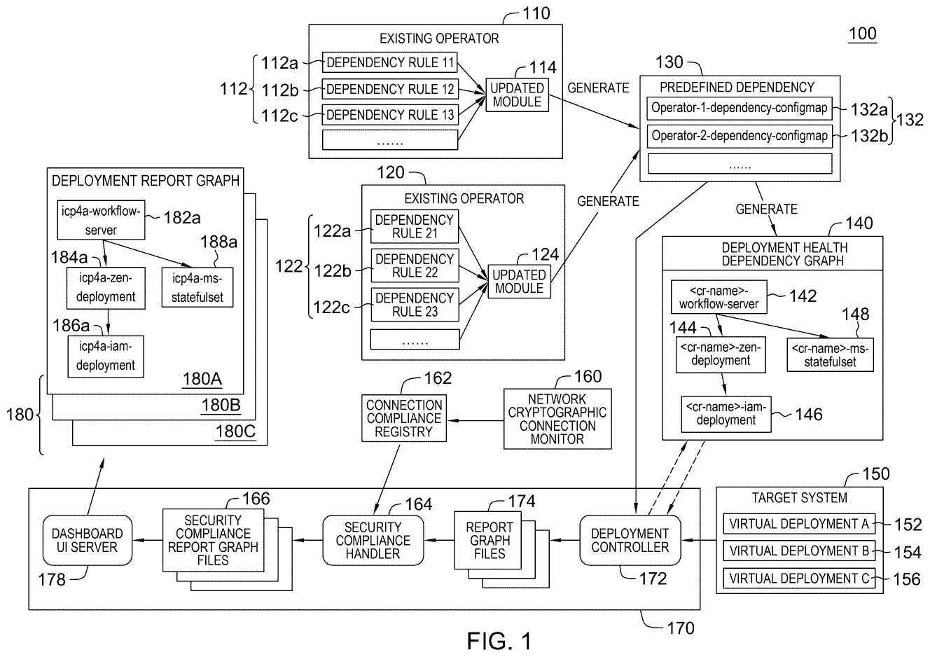

FIG. 1 illustrates an architecture for a resource deployment compliance engine 100 in accordance with some embodiments of the present disclosure. The resource deployment compliance engine 100 includes a first existing operator 110 and a second existing operator 120. The first existing operator 110 includes a set 112 of dependency rules and an updated module 114; the set 112 of dependency rules includes dependency rule 11 112a, dependency rule 12 112b, and dependency rule 13 112c. The second existing operator 120 includes a set 122 of dependency rules and an updated module 124; the set 122 of dependency rules includes dependency rule 21 122a, dependency rule 22 122b, and dependency rule 23 122c.

The updated modules 114 and 124 generate a predefined dependency store 130. The predefined dependency store 130 stores a dependency configmap set 132 including a first operator dependency configmap 132a and a second operator dependency configmap 132b. The predefined dependency store 130 generates a deployment health dependency graph 140 with the operator dependency data. The deployment health dependency graph 140 includes a workflow server 142, a zen deployment 144, and identity and access management deployment 146, and a message service statefulset 148.

The predefined dependency store 130 submits the operator dependency data to a deployment controller 172 in a controller set 170. A target system 150 with virtual deployments 152, 154, and 156 submits data to the deployment controller 172; in some embodiments, the target system 150 may be a virtual deployment. The deployment controller 172 generates report graph files 174 and submits the report graph files 174 to a security compliance handler 164.

A network cryptographic connection monitor 160 submits network action data to a connection compliance registry 162. In some embodiments, the network cryptographic connection monitor 160 may monitor the network (e.g., the target system 150 or a containerized environment cluster) to obtain the network action data. In some embodiments, the network cryptographic connection monitor 160 may extract encryption data from the network action data and/or detect connection security data from the encryption data. The connection compliance registry 162 may store the network action data which may include encryption data and/or connection security data. The connection compliance registry 162 submits the network action data to the security compliance handler 164.

The security compliance handler 164 generates security compliance report graph files. The security compliance report graph files 166 may include data from the report graph files and/or network action data. The security compliance report graph files 166 are submitted to a dashboard user interface (UI) server 178. The dashboard UI server 178 generates a set 180 of deployment report graphs 180A, 180B, and 180C with the security compliance report graph files 166. The first deployment report graph 180A includes a server 182a, a zen deployment 184a, an identity access management deployment 186a, and a message service statefulset 188a.

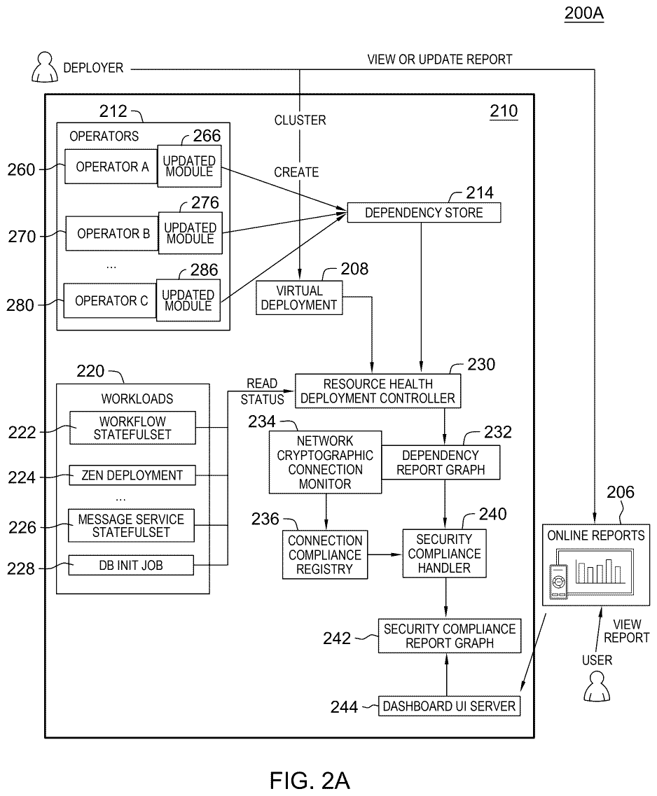

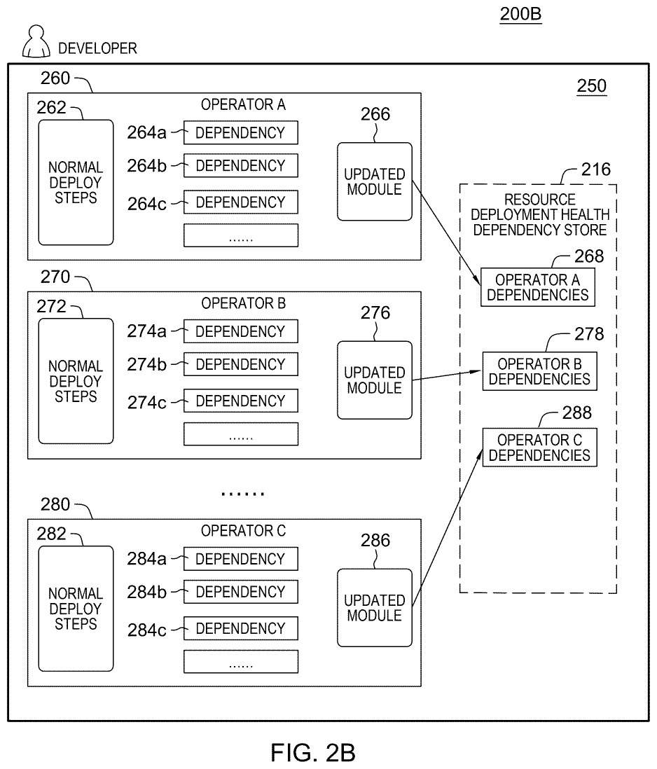

FIG. 2A depicts a deployment architecture for a resource deployment compliance system 200A in accordance with some embodiments of the present disclosure. The system 200A includes a cluster 210; the cluster 210 may be a container-based cluster. The cluster 210 includes an operator group 212. The operator group 212 includes operator A 260 with an updated module 266, operator B 270 with an updated module 276, and operator C 280 with an updated module 286. In some embodiments, the operator group 212 may include more or fewer operators.

The updated modules 266, 276, and 286 in the operator group 212 submit data to a dependency store 214. The updated modules 266, 276, and 286 may report dependencies to the dependency store 214. The dependency store 214 reports the data (e.g., dependency data) to a resource health deployment controller 230. A user (e.g., an end user) or a deployer (e.g., an administrator) may generate a virtual deployment 208; the virtual deployment 208 submits data to the resource health deployment controller 230.

The cluster 210 includes workloads 220; the workloads 220 include a workflow statefulset 222, a zen deployment 224, a message service statefulset 226, and a database initiation job 228. In some embodiments, there may be more, fewer, and/or different workloads and/or types of workloads in the workloads 220. The resource health deployment controller 230 reads the status of the workloads 220.

The resource health deployment controller 230 generates and/or updates a dependency report graph 232; in some embodiments, the health deployment controller 230 generates and/or updates the dependency report graph 232 with the dependency information from the dependency store 214, the virtual deployment 208 data, and/or the status of the workloads 220. The resource health deployment controller 230 submits the dependency report graph 232 to a security compliance handler 240.

A network cryptographic monitor 234 submits network data to a connection compliance registry 236. The network cryptographic monitor 234 may monitor transactions over the connections within the network to identify connections within the network; the network cryptographic monitor 234 may store the connections data in the connection compliance registry 236. The connection compliance registry 236 submits the network data to the security compliance handler 240.

The security compliance handler 240 generates a security compliance report graph 242. In some embodiments, the security compliance handler 240 may use data from the dependency report graph 232 and/or data from the connection compliance registry 236 to generate the security compliance report graph 242.

The deployment architecture for a resource deployment compliance system 200A includes online reports 206. In some embodiments, a user (e.g., a deployer or a tester) may view the online reports 206. The online reports 206 are submitted to a dashboard UI server 244 and used to generate and/or update the security compliance report graph 242.

FIG. 2B illustrates a development architecture for a resource deployment compliance system 200B in accordance with some embodiments of the present disclosure. The system 200B includes an environment 250 (e.g., a cluster or a pod). The environment 250 includes operator A 260 with normal deploy steps 262 and an updated module 266; operator A 260 also includes a first dependency 264a, a second dependency 264b, and a second dependency 264c. The environment 250 includes operator B 270 with normal deploy steps 272 and an updated module 276; operator B 270 also includes a first dependency 274a, a second dependency 274b, and a second dependency 274c. The environment 250 includes operator C 280 with normal deploy steps 282 and an updated module 286; operator C 280 also includes a first dependency 284a, a second dependency 284b, and a second dependency 284c. In some embodiments, the environment 250 may include more or fewer operators. In some embodiments, the operators may include more or fewer dependencies.

The updated modules 266, 276, and 286 in the operators submit data to a resource deployment health dependency store 216. The updated modules 266, 276, and 286 report dependencies to the resource deployment health dependency store 216. The updated module 266 of operator A 260 reports operator A dependencies 268 to the resource deployment health dependency store 216, the updated module 276 of operator B 270 reports operator B dependencies 278 to the resource deployment health dependency store 216, and the updated module 286 of operator C 280 reports operator C dependencies 288 to the resource deployment health dependency store 216.

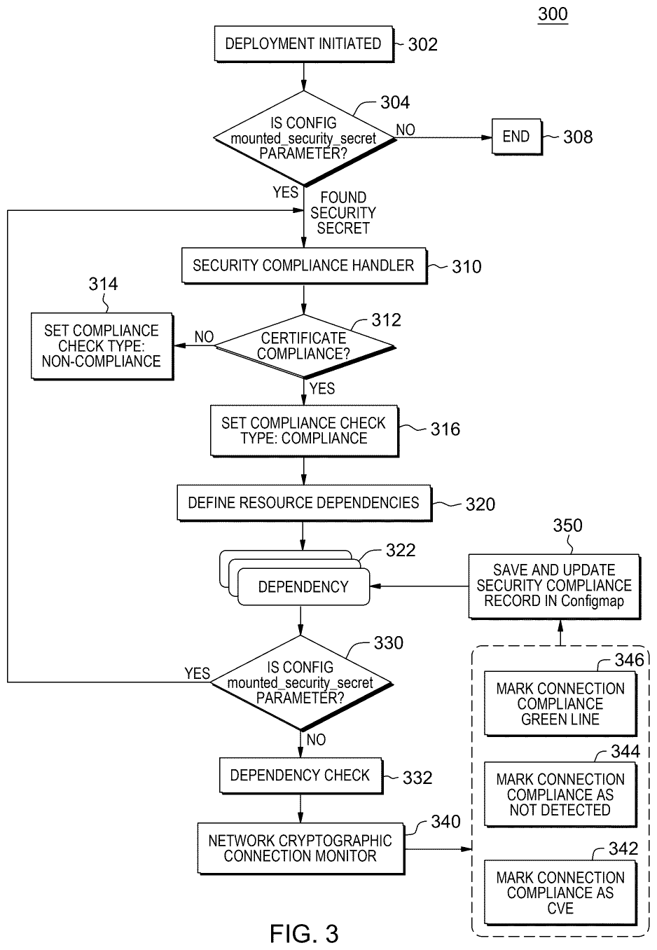

FIG. 3 depicts a flowchart 300 of a resource deployment system in accordance with some embodiments of the present disclosure. The flowchart 300 includes initiating 302 a deployment and determining 304 whether the deployment has a mounted security secret parameter. The flowchart 300 illustrates that if a deployment does not have a mounted security secret parameter, the process ends 308; in some embodiments, the process ends 308 because no mounted security secret parameter may indicate, for example, that the deployment is not subject to the current security protocols. In some embodiments, if a deployment does not have a mounted security secret parameter, a mounted security secret parameter may be added to the deployment. If a mounted security secret parameter is found, the flowchart 300 proceeds to the mounted security secret parameter being submitted to the security compliance handler 310. The security compliance handler 310 checks 312 the compliance of the mounted security secret parameter; if the mounted security secret parameter is not compliant, the security compliance handler 310 sets the compliance check type to non-compliant 314 to indicate that the mounted security secret parameter is non-compliant with current security protocols.

If the mounted security secret parameter is compliant, the security compliance handler 310 sets the compliance check type to compliant 316 to indicate that the mounted security secret parameter is compliant with current security protocols. The flowchart 300 proceeds by defining 320 resource dependencies and obtaining the dependencies 322. The flowchart 300 continues by determining 330 whether the dependencies 322 are configured with mounted security secret parameters. The flowchart 300 then loops back to the security compliance handler 310 if one or more dependencies 322 are configured with a mounted security secret parameter to determine whether or not the mounted security secret parameter is compliant with current security protocols. If the dependencies 322 do not have mounted security secret parameters, the flowchart 300 proceeds to performing a dependency check 332.

The flowchart 300 continues by a network cryptographic connection monitor 340 monitoring the network to determine the compliance status of each connection within the network. A non-compliant connection is marked as CVE 342, a missing connection is marked as not detected 344, and a compliant connection is marked as compliant with a green line 346. The connection status data is saved and used to update a security compliance record 350 in a configmap. The flowchart 300 loops to the dependencies 322.

The flowchart 300 loops from saving and updating the compliance record 350 in a configmap to the dependencies 322 to continue the process of determining 330 whether the dependencies 322 are configured with mounted security secret parameters. In some embodiments, each of the dependencies 322 may be checked individually such that a first loop will determine whether a first dependency is configured with mounted security secret parameters, a second loop will determine whether a second dependency is configured with mounted security secret parameters, and so on. For example, in an embodiment with one dependency determination per loop, a single source object with five dependencies would loop back to the dependencies 322 four times such that the loop is performed five times (once per dependency).

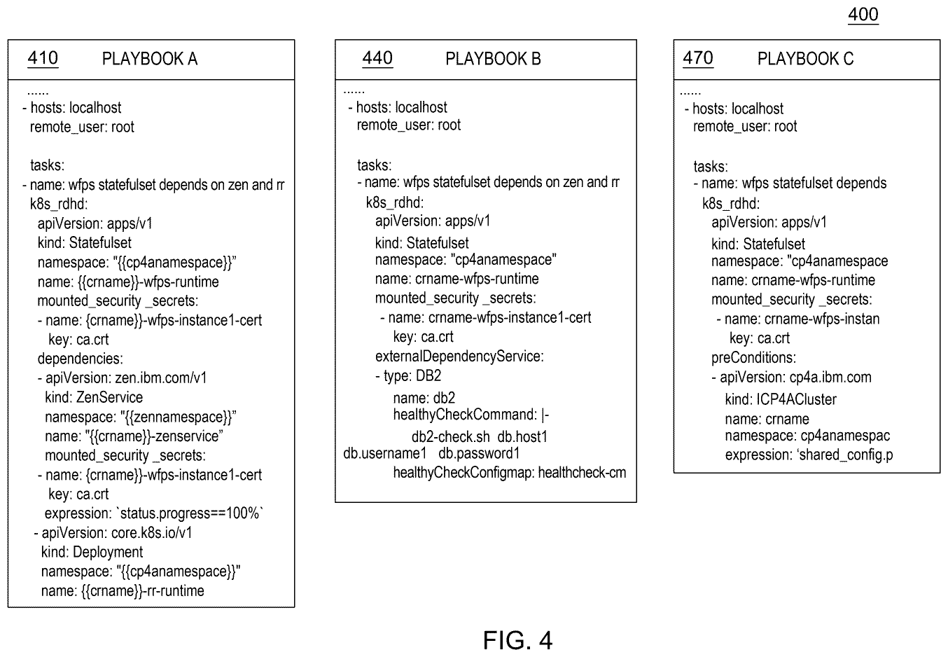

FIG. 4 illustrates a set 400 of example playbooks for a resource deployment system in accordance with some embodiments of the present disclosure. Playbooks may be used to implement resource deployment compliance. A containerized system may have an RDHD module to extract dependency rules from tasks; in some embodiments, the RDHD module may be customized. A field may be included in a mounted secret that contains information related to certificate configuration. A mounted security secret parameter may include a name field with the name of the secret that contains the certificate or key as well as a key field with the name filed in the secret which contains the binary value of a certificate or key.

The set 400 of example playbooks shown in FIG. 4 includes playbook A 410, playbook B 440, and playbook C 470. Each playbook includes at least one mounted security secret parameter. Each mounted security secret parameter includes a name and a key for the mounted security secret parameter.

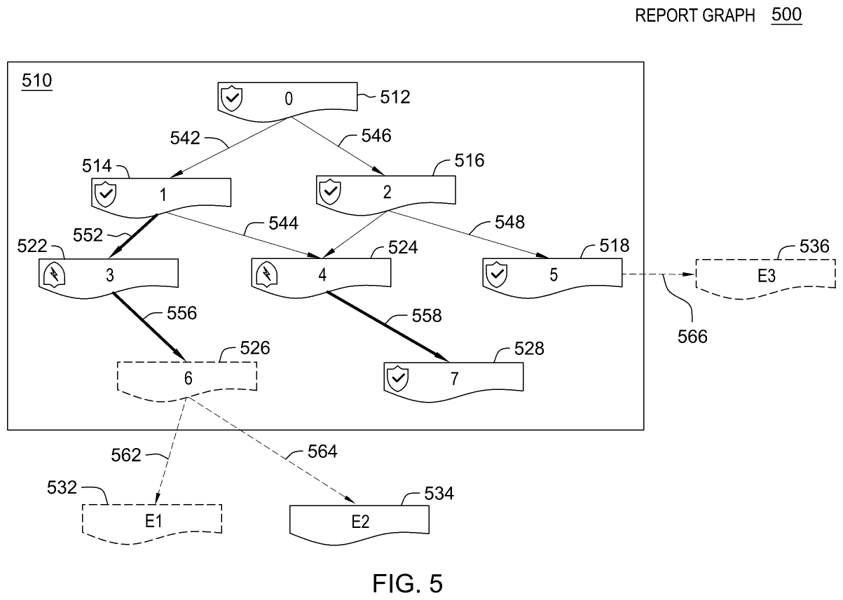

FIG. 5 depicts a compliance report graph 500 in accordance with some embodiments of the present disclosure. The compliance report graph 500 includes resources 512, 514, 516, 518, 522, 524, 526, and 528 within a cluster 510 as well as external resources 532, 534, and 536 which are outside of the cluster 510. In some embodiments, a cluster (e.g., cluster 510) may be deployed by a first entity (e.g., a first company) and the resources outside of a cluster (e.g., external resources 532, 534, and 536) may be deployed by one or more other entities (e.g., a second company and a collaborating organization). Some of the resources 512, 514, 516, 518, and 528 in the compliance report graph 500 are compliant with current security protocols and thus have shielded checkmark indicators. Some of the resources 522 and 524 are not compliant with current security protocols and thus have disconnected shield indicators.

Resources 526, 532, 534, and 536 that have not been determined to be either compliant or non-compliant with current security protocols are not marked with indicators. A resource may not be marked as compliant or non-compliant because the system (e.g., the resource deployment compliance engine 100 as shown in FIG. 1) is unable to locate the resource (e.g., the resource is missing), the system is unable to locate the connection to the resource (e.g., a connection and/or an intermediary resource is missing), and/or the resource is outside of the reach of the system and thus the system does not have access to the resource data. In the report graph 500 of FIG. 5, a resource 526 within the cluster 510 is missing and two external resources 532 and 536 outside of the cluster 510 are missing as indicated by the dashed lines.

The compliance report graph 500 includes the connections 542, 544, 546, 548, 552, 556, 558, 562, 564, and 566 between the resources 512, 514, 516, 518, 522, 524, 526, 528, 532, 534, and 536. Connections 542, 544, 546, and 548 without security vulnerabilities are shown with standard arrows, connections 552, 556, and 558 with security vulnerabilities are shown with bolded arrows, and missing connections 562, 564, and 566 are shown with dashed arrows to indicate that the connection was not detected. In some embodiments, the status of each connection as compliant (e.g., no security vulnerabilities identified), not compliant (e.g., security vulnerabilities identified), or missing (e.g., undetected) is determined by the network monitor (e.g., the network cryptographic connection monitor 160 shown in FIG. 1).

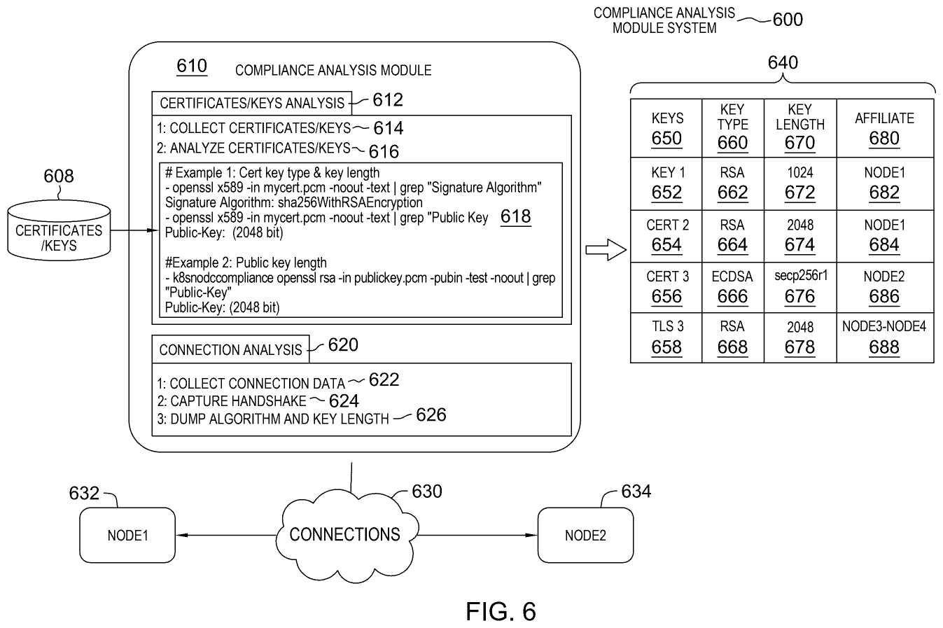

FIG. 6 illustrates a compliance analysis module system 600 of a resource deployment compliance system in accordance with some embodiments of the present disclosure. The compliance analysis module system 600 includes a compliance analysis module 610. The compliance analysis module 610 receives certificates and/or keys from a database 608, and the compliance analysis module 610 performs an analysis 612 on the certificates and/or keys. The analysis 612 includes collecting 614 certificates and/or keys and analyzing 616 the certificates and/or keys. The compliance analysis module 610 of FIG. 6 includes examples 618 of certificate and/or key analysis 612.

The compliance analysis module 610 performs an analysis 620 on the connections within a container-based system. As shown in FIG. 6, there is a first node 632 and a second node 634 that are part of the container-based system; a container-based system may have any number of nodes and/or connections in accordance with the present disclosure. The compliance analysis module 610 receives connections 630 data about the nodes; in some embodiments, the connections 630 may be transport layer security (TLS) connections and the connections 630 data may be TLS connections data. The connection analysis 620 includes collecting 622 connection data, capturing 624 a handshake, and dumping 626 the algorithm and key length.

The compliance analysis module 610 analyzes the resources and the connections to produce information about the system. In FIG. 6, the data is output into a table 640. The table 640 includes columns for keys 650, key types 660, key lengths 670, and affiliates 680. The keys 650 in the table include key 1 652, certificate 2 654, certificate 3 656, and TLS 3 658. The key types 660 in the table include RSA 662, RSA 664, ECDSA 666, and RSA 668. The key lengths 670 in the table include 1024 672, 2048 674, secp256r1 676, and 2048 3 678. The affiliates 680 in the table include node1 682, node1 684, node2 686, and node3-node4 688.

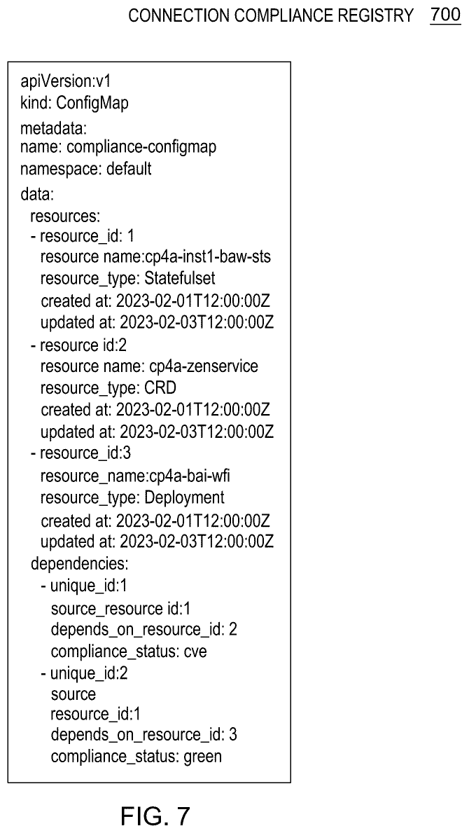

FIG. 7 depicts a connection compliance registry 700 for a resource deployment compliance system in accordance with some embodiments of the present disclosure. The connection compliance registry 700 is an example registry of network security compliance statuses of connections within a container-based system. In some embodiments, a network monitor (e.g., the network cryptographic connection monitor 234 of FIG. 2A) may detect the connection compliance statuses and/or generate the connection compliance registry 700.

The connection compliance registry 700 of FIG. 7 records the connection data, including the compliance data, between resources within a container-based system. The connection compliance registry 700 records the data of a system with three resources and two connections; one connection is marked non-compliant (here, “cve”) to indicate a security vulnerability and the other connection is marked compliant (here, “green”) to indicate that no security vulnerability was identified. In accordance with the present disclosure, a connection compliance registry may record the connection data of any number of connections between any number of resources, and any of the connections may be compliant, non-compliant, or missing.

A computer-implemented method in accordance with the present disclosure may include monitoring network actions between resources within a network and extracting encryption data from the network actions. The method may include detecting connection security data from the encryption data and obtaining a resource health report for a resource in the network. The method may include merging connection security data with the resource health report and generating a security compliance report.

In some embodiments of the present disclosure, monitoring the network actions may include capturing an exchange between the resources. In some embodiments, an exchange between resources may be a network action; in some embodiments, a network action may be a client message or a server response. In some embodiments, the exchange may include a handshake, a message, and a response to the message. In some embodiments, the exchange may be between a server and a client. In some embodiments, the exchange may include a client message and a server response.

In some embodiments of the present disclosure, the encryption data may include at least one of an encryption algorithm, a cryptographic certificate, an encryption key, and an encryption key length. In some embodiments, the method may include extracting a key length from the network actions; the connection security data may be based on the encryption data and the key length.

In some embodiments of the present disclosure, the method may include generating a virtual deployment instance. In some embodiments, the virtual deployment instance may include a custom resource.

In some embodiments of the present disclosure, the method may include generating a resource deployment health report graph. In some embodiments, the resource deployment health report graph may include resources within the network, resource relationships within the network, and statuses within the network. In some embodiments, the resource deployment health report graph may be a configmap.

In some embodiments of the present disclosure, the method may include updating a resource deployment health report graph.

In some embodiments of the present disclosure, the method may include building the resource health report. In some embodiments, building the resource health report may include analyzing dependencies within the network, defining the resources within the network, defining relationships within the network, and defining conditions within the network.

In some embodiments of the present disclosure, the method may include generating a resource deployment health dependency store. In some embodiments, the resource health report is based on the resource deployment health dependency store.

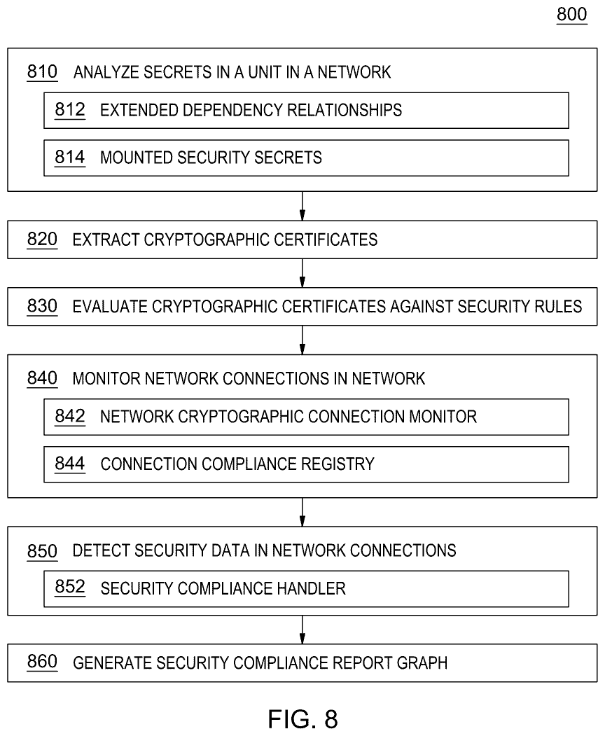

FIG. 8 illustrates a computer-implemented resource deployment compliance method 800 in accordance with some embodiments of the present disclosure. The method 800 includes analyzing 810 secrets in a unit in a network; the secrets include extended dependency relationships 812 and mounted security secrets 814. The method 800 includes extracting 820 cryptographic certificates and evaluating 830 the cryptographic certificates against security rules.

The method 800 includes monitoring 840 network connections in a network. A network cryptographic connection monitor 842 performs the network connection monitoring 840 and stores the connection data in a connection compliance registry 844. The method 800 includes detecting 850 security data in the network connections; a security compliance handler 852 performs the network connection security data detecting. The method 800 includes generating 860 a security compliance report graph.

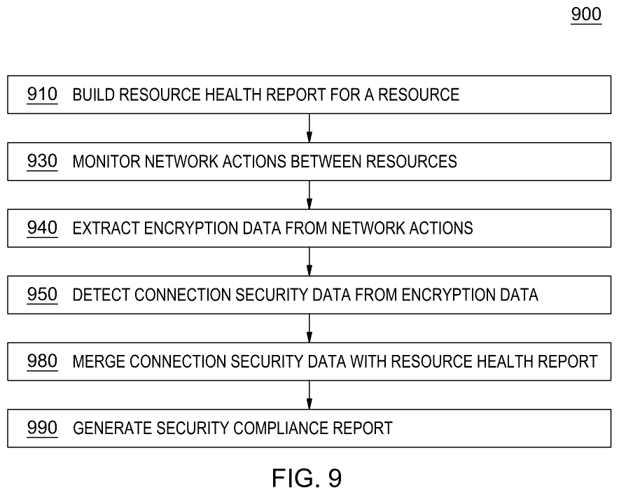

FIG. 9 depicts a method 900 for a container-based deployment system in accordance with some embodiments of the present disclosure. The method 900 includes building 910 a resource health report for a resource in a system and monitoring 930 network actions between resources in the system. The method 900 includes extracting 940 encryption data from network actions and detecting 950 connection security data from the network action encryption data. The method 900 includes merging 980 the connection security data with the resource health report and generating 990 a security compliance report.

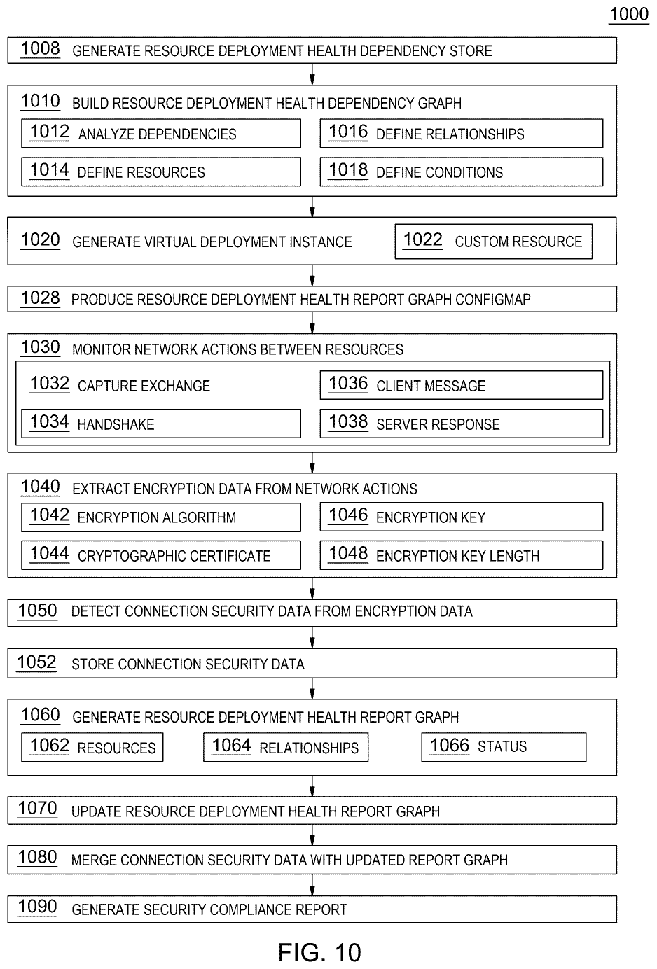

FIG. 10 illustrates a computer-implemented method 1000 for a container-based deployment system accordance with some embodiments of the present disclosure. The method 1000 includes generating 1008 a resource deployment health dependency store and building 1010 a resource deployment health dependency graph for a resource in a system. Building 1010 a resource deployment health dependency graph includes analyzing 1012 the dependencies within the system, defining 1014 the resources within the system, defining 1016 the relationships within the system, and defining 1018 the conditions within the system.

The method 1000 includes generating 1020 a virtual deployment instance; the virtual deployment instance includes a custom resource 1022. The method 1000 includes producing 1028 a resource deployment health report graph configmap.

The method 1000 includes monitoring 1030 network actions between resources in the system. Network actions include exchanges on the network. Monitoring 1030 the network actions includes capturing 1032 an exchange between resources. The exchange includes a handshake 1034, a client message 1036, and a server response 1038.

The method 1000 includes extracting 1040 encryption data from network actions. The encryption data may include an encryption algorithm 1042, a cryptographic certificate 1044, an encryption key 1046, and an encryption key length 1048. In some embodiments of the present disclosure, the encryption data may include multiple encryption algorithms, cryptographic certificates, encryption keys, and/or encryption key lengths.

The method 1000 includes detecting 1050 connection security data from the encryption data. The method 1000 includes storing 1052 the connection security data; in some embodiments, the connection security data may be stored in a registry (e.g., connection compliance registry 162 as shown in FIG. 1).

The method 1000 includes generating 1060 a resource deployment health report graph. The resource deployment health report graph includes resources 1062, relationships 1064, and status data 1066 for the resources 1062 and relationships 1064.

The method 1000 includes updating 1070 the resource deployment health report graph, merging 1080 the connection security data with the updated report graph, and generating 1090 a security compliance report.

A computer program product in accordance with the present disclosure may include a computer readable storage medium having program instructions embodied therewith. The program instructions may be executable by a processor to cause the processor to perform a function. The function may include monitoring network actions between resources within a network and extracting encryption data from the network actions. The function may include detecting connection security data from the encryption data and obtaining a resource health report for a resource in the network. The function may include merging connection security data with the resource health report and generating a security compliance report.

In some embodiments of the present disclosure, monitoring the network actions may include capturing an exchange between the resources. In some embodiments, an exchange between resources may be a network action; in some embodiments, a network action may be a client message or a server response. In some embodiments, the exchange may include a handshake, a message, and a response to the message. In some embodiments, the exchange may be between a server and a client. In some embodiments, the exchange may include a client message and a server response.

In some embodiments of the present disclosure, the encryption data may include at least one of an encryption algorithm, a cryptographic certificate, an encryption key, and an encryption key length. In some embodiments, the function may include extracting a key length from the network actions; the connection security data may be based on the encryption data and the key length.

In some embodiments of the present disclosure, the function may include generating a virtual deployment instance. In some embodiments, the virtual deployment instance may include a custom resource.

In some embodiments of the present disclosure, the function may include generating a resource deployment health report graph. In some embodiments, the resource deployment health report graph may include resources within the network, resource relationships within the network, and statuses within the network. In some embodiments, the resource deployment health report graph may be a configmap.

In some embodiments of the present disclosure, the function may include updating a resource deployment health report graph.

In some embodiments of the present disclosure, the function may include building the resource health report. In some embodiments, building the resource health report may include analyzing dependencies within the network, defining the resources within the network, defining relationships within the network, and defining conditions within the network.

In some embodiments of the present disclosure, the function may include generating a resource deployment health dependency store. In some embodiments, the resource health report is based on the resource deployment health dependency store.

It is noted that various aspects of the present disclosure may be described by narrative text, flowcharts, block diagrams of computer systems, and/or block diagrams of the machine logic included in computer program product (CPP) embodiments. With respect to any flowcharts (depending upon the technology involved), the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices.

The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc), or any suitable combination thereof. A computer-readable storage medium should not be construed as storage in the form of transitory signals per se such as radio waves, other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation, or garbage collection, but this does not render the storage device transitory because the data is not transitory while it is stored.

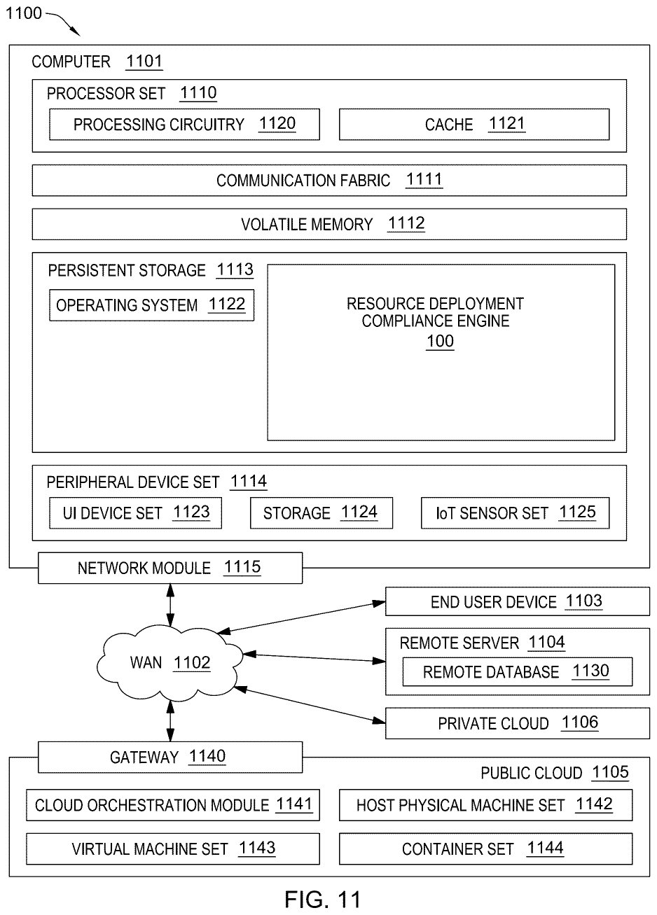

FIG. 11 depicts a block diagram illustrating an embodiment of a computer system configured to operate in a network environment (including a cloud environment), and the components thereof, upon which embodiments including systems and methods described herein may be implemented in accordance with the present disclosure.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device such as during access, de-fragmentation, or garbage collection, but this does not render the storage device transitory because the data is not transitory while it is stored.

Computing environment 1100 contains an example of an environment for the execution of at least some of the computer code involved in performing the inventive methods, such as resource deployment compliance engine 100. In addition to resource deployment compliance engine 100, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and resource deployment compliance engine 100, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

The computer 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of the computing environment 1100, detailed discussion is focused on a single computer, specifically computer 1101, to keep the presentation as simple as possible. The computer 1101 may be located in a cloud, even though it is not shown in a cloud in FIG. 11. On the other hand, the computer 1101 is not required to be in a cloud except to any extent as may be affirmatively indicated.

Processor set 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer-readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in resource deployment compliance engine 100 in persistent storage 1113.

Communication fabric 1111 is the signal conduction path that allows the various components of computer 1101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

Persistent storage 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface-type operating systems that employ a kernel. The code included in resource deployment compliance engine 100 typically includes at least some of the computer code involved in performing the inventive methods.

Peripheral device set 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

Network module 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer-readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

Remote server 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

Public cloud 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

CLOUD COMPUTING SERVICES AND/OR MICROSERVICES (not separately shown in FIG. 11): private and public clouds 1106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

Various aspects of the present disclosure are described by narrative text, flowcharts, block diagrams of computer systems, and/or block diagrams of the machine logic included in CPP embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system comprising:
a memory; and
a processor in communication with said memory, said processor being configured to perform operations, said operations comprising:
monitoring network actions between resources within a network;
extracting encryption data from said network actions;
detecting connection security data from said encryption data;
obtaining a resource health report for a resource in said network;
merging connection security data with said resource health report; and
generating a security compliance report.

2. The system of claim 1, wherein monitoring said network actions comprises:
capturing an exchange between said resources.

3. The system of claim 2, wherein said exchange comprises:
a handshake;
a message; and
a response to said message.

4. The system of claim 1, wherein said encryption data includes at least one from the group consisting of an encryption algorithm, a cryptographic certificate, an encryption key, and an encryption key length.

5. The system of claim 1, said operations further comprising:
generating a virtual deployment instance.

6. The system of claim 1, said operations further comprising:
generating a resource deployment health report graph.

7. The system of claim 1, said operations further comprising:
building said resource health report.

8. A method comprising:
monitoring network actions between resources within a network;
extracting encryption data from said network actions;
detecting connection security data from said encryption data;
obtaining a resource health report for a resource in said network;
merging connection security data with said resource health report; and
generating a security compliance report.

9. The method of claim 8, wherein monitoring said network actions comprises:
capturing an exchange between said resources.

10. The method of claim 9, wherein said exchange comprises:
a handshake;
a message; and
a response to said message.

11. The method of claim 8, wherein said encryption data includes at least one from the group consisting of an encryption algorithm, a cryptographic certificate, an encryption key, and an encryption key length.

12. The method of claim 8, further comprising:
generating a virtual deployment instance.

13. The method of claim 8, further comprising:
generating a resource deployment health report graph.

14. The method of claim 13, wherein said resource deployment health report graph includes resources within said network, resource relationships within said network, and statuses within said network.

15. The method of claim 8, further comprising:
building said resource health report.

16. A computer program product comprising a computer readable storage medium having program instructions embodied therewith, said program instructions executable by a processor to cause said processor to perform a function, said function comprising:
monitoring network actions between resources within a network;
extracting encryption data from said network actions;
detecting connection security data from said encryption data;
obtaining a resource health report for a resource in said network;
merging connection security data with said resource health report; and
generating a security compliance report.

17. The computer program product of claim 16, wherein monitoring said network actions comprises:
capturing an exchange between said resources.

18. The computer program product of claim 16, wherein said encryption data includes at least one from the group consisting of an encryption algorithm, a cryptographic certificate, an encryption key, and an encryption key length.

19. The computer program product of claim 16, said function further comprising:
generating a virtual deployment instance.

20. The computer program product of claim 16, said function further comprising:
generating a resource deployment health report graph.
